(19) United States
(12) Patent Application Publication
(10) Pub. No.: US 2005/0242067 A1
(43) Pub. Date: Nov. 3, 2005

(54) Method and device for welding workpieces

(75) Inventors: Ralf Bernhardt, Leonberg (DE); Klaus Goth, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTGART (DE)

(21) Appl. No.: 10/512,411

(22) PCT Filed: Mar. 19, 2003
(86) PCT No.: PCT/EP03/02848

§ 371 Date: Jun. 27, 2005

(30) Foreign Application Priority Data
Apr. 24, 2002 (DE) 102 18 179.9

(51) Int. Cl. B23K 15/00; B23K 10/02; B23K 26/20

(52) U.S. Cl. 219/121.14; 219/121.64; 219/121.46

(57) ABSTRACT

A method is suggested for welding workpieces, particularly coated workpieces, and a device is suggested for implementing the method. By means of the device, at least at the welding point, alternately a zero gap and an outgassing gap adjustable in its height for the escape of the gases and vapors occurring during the welding operation can be generated, for this purpose at least a first workpiece being moved relative to a second workpiece. The method is characterized in that the relative movement between the workpieces is force-controlled and/or path-controlled.

The invention relates to a method of welding workpieces according to the preamble of claim 1, and to a device for welding workpieces according to the preamble of claim 12.

Methods and devices of the type addressed here are known from German Patent Document DE 42 19 549 C2. In the case of the known welding methods, a gap between the coated workpieces is created during the welding process, from which gap vapors may escape which occur during welding. When continuous laser irradiation is used for welding the workpieces, the gap is maintained continuously during the welding operation, whereas, during a pulsed radiation, it is present only during the interaction of the laser pulse with the workpieces. For this purpose, at least one of the workpieces is caused to carry out vibrations by means of a vibration generator. It was found that, in the process, the height of the gap can only be adjusted with insufficient precision, which, however, is required when laser welding coated workpieces, (however, sufficient precision is required when laser welding coated workpieces? translator) because a gap height which is too low may lead to a melt ejection and an excessive gap height may lead to an underarching of the seam or root, in which case the gap tolerance is relatively low.

It is an object of the invention to provide a method of the initially mentioned type in which the gap height can be reproducibly adjusted with high precision without the requirement that, for this purpose, one of the workpieces has to be provided with molding characteristics used as spacers. It is another object of the invention to provide a device of the initially mentioned type, by means of which the method according to the invention can be implemented.

For achieving this object, a method with the characteristics of claim 1 is suggested. It provides that at least one of the workpieces to be welded together is moved relative to the other workpiece, in order to alternately generate a zero gap (gap height equal to zero) and an outgassing gap adjustable in its height for the escaping of the gases and vapors occurring during the welding operation. The method is distinguished in that the relative movement between the workpieces is force-controlled and/or path-controlled. Thus, —differently than in the known methods—, the movement is very controlled, so that the height of the outgassing gap can be precisely adjusted, that is, can be adjusted within a small tolerance range. As a result, melt ejections, as they occur when the height of the outgassing gap is too low, and seam or root underarching, which frequently occurs when the height of the outgassing gap is too large, can be reliably prevented.

In a preferred embodiment of the method, the force-path control takes place in that, for generating the technical zero gap, the relative movement between the workpieces is force-controlled, and in that, for generating an outgassing gap of a defined height, the relative movement between the workpieces is path controlled. Therefore, if during the welding process, only one of the workpieces is moved relative to the other workpiece, in a first step for forming the technical zero gap, this workpiece is pressed against the other workpiece, in which case the contact pressing force is increased until it reaches a desired adjustable value (F_target). Preferably, at least one contact pressure element is used for this purpose which can be displaced in the direction of the workpieces and in the opposite direction. The force of this contact pressure element exercised upon the workpiece or the workpieces is detected by means of sensors and can therefore be precisely adjusted. In this phase of the welding process, the path which the contact pressure element covers until the contact pressure force reaches the desired value (F_target) has no influence on the controlling of the relative movement between the workpieces.

After the technical zero gap has been established between the workpieces and a certain definable time duration has been maintained, in a second step, the contact pressure element is withdrawn by a definable or defined distance Δz, which corresponds to the desired height of the outgassing gap. According to a first embodiment, in which the contact pressure element is connected with the workpiece directly or by way of at least one transfer element in a force-locking and/or form-locking manner, a taking-along of the workpiece interacting with the contact pressure element takes place while forming the outgassing gap. According to a particularly preferred embodiment, the outgassing gap is produced in that, after the contact pressure element was withdrawn, or during the withdrawal of the contact pressure element, the workpiece elastically deformed in the first step automatically restores/deforms itself as a result of its spring-elastic characteristics. In the process, it places itself against the contact pressure element arranged in the withdrawn position. In the second embodiment, it has to be ensured that the path by which the contact pressure element is withdrawn from the welding point is only so large that the workpiece also springs back so far, so that it comes to rest against the contact pressure element arranged in the withdrawn position. Otherwise, the height of the outgassing gap would not be defined. Alternatively, spreading devices could be used here which reach into the gap and are moved apart, whereby the workpiece interacting with the contact pressure element is placed against the contact pressure element arranged in the withdrawn position. As an alternative, suction systems can also ensure the placing against the contact pressure element.

If only one displaceable contact pressure element is used for—as described above—alternately generating a zero gap and an outgassing gap between the workpieces, the other workpiece, which does not come directly in contact with the contact pressure element, has to be arranged in a fixed position which remains almost the same during the welding process. The relative movement between the workpieces therefore essentially takes place here by a movement of the workpiece interacting with the contact pressure element.

According to another embodiment of the method, the relative movement between the workpieces is only force-controlled. For generating the technical zero gap, one of the workpieces is pressed by means of a contact pressure element with a defined adjustable contact pressure force (F_target) against the other workpiece. Subsequently, the contact pressure force is reduced to such an extent that the desired outgassing gap is adjusted, which in a preferred embodiment takes place in that the at least one elastically deformed workpiece is deformed back, thus, virtually stands up in the area of the welding point and thereby continues to rest against the contact pressure element.

In another embodiment of the method, at least two displaceable contact pressure elements are provided which are arranged at a distance from one another and are each assigned to one of the workpieces. The zero gap and the outgassing gap can be generated here in that both contact pressure elements are moved toward one another or away from one another. Here also, the generating of the zero gap takes place by means of the force control of the contact pressure elements and the generating of the outgassing gap takes place by the path control of the contact pressure elements. As an alternative, it may be provided that, for generating the zero gap or the outgassing gap, only one of the two displaceable contact pressure elements is displaced relative to the other contact pressure element, while, when the respective other gap is generated, both contact pressure elements are moved again.

An embodiment of the method is particularly preferred in which the outgassing gap has a height which is in the range of from 0.1 mm to 1 mm. When welding coated workpieces, particularly metal sheets as used in vehicle body construction, gap heights in the range of approximately from 0.1 mm to 0.3 mm were found to be particularly preferable. The height of the outgassing gap is preferably adjusted as a function of at least one parameter, for example, of the workpiece material and/or the workpiece thickness, if available, the type of coating of the workpieces and the like.

Furthermore, an embodiment of the method is preferred which is characterized in that, for generating a gap between the workpieces to be welded together, of which preferably at least one is a sheet metal part, the workpieces are placed upon one another in a force-free manner at the welding point, the height of the gap being—preferably exclusively—determined by material-caused and/or production-caused inaccuracies of the workpieces. In this context, a “force-free placing upon one another” of the workpieces means that these are not pressed against one another but that only the own weight of the upper workpiece acts upon the lower workpiece. It was found that, in the case of two metal sheets placed loosely (force-free) upon one another of, in each case, a thickness in the range of from approximately 0.7 mm to 1.5 mm, a gap remains which has a height of several 1/10ths of a millimeter between the metal sheets. In the case of coated sheet metal parts, this gap is sufficiently high for letting vapors and gases escape which occur during the welding and which are the result of the evaporation of the coating in the area of the welding point. Preferably, at least in the area of the welding point, the workpieces have no projections, elevations or the like, used as spacers between the workpieces and also do not have to be spaced away from one another by means of spacers (spreading devices) in order to generate an outgassing gap. An exact adjustment of the height of the outgassing gap in the above-mentioned manner takes place only after first a technical zero gap has been generated at least once between the workpieces and the contact pressure element was subsequently lifted/withdrawn by a defined path off the welding point or the contact pressure force was reduced by a defined value.

Finally, an embodiment of the method is preferred in which the workpieces to be welded together are welded to one another by means of high-energy irradiation. The welding methods used here are, for example, laser beam welding, electron beam welding or plasma arc welding. Preferably, the welding takes place by means of continuous irradiation; that is, the irradiation remains aimed at the welding point even after the technical zero gap has been generated between the workpieces. As a result of the application of the irradiation when the gap is closed (zero gap), the pressure rises in the area of the welding point because of the occurring vapors and gases which cannot escape. However, the outgassing gap is generated before melt ejections occur. The time duration of how long the zero gap can maximally be maintained can be determined, for example, empirically.

When the tensioning technique is stationary, the tensioning element can also first achieve the zero gap and then, in a path controlled manner, the outgassing gap. Only then will the high-energy irradiation (laser beam) be switched on and the welding will take place.

The method according to the invention can particularly advantageously be used when welding sheet metal/steel parts having a coating of a low evaporation temperature, for example, vehicle body sheet metal parts coated with zinc or with a zinc alloy.

Additional advantageous embodiments of the method are obtained from combinations of the characteristics mentioned in the subclaims.

For achieving this object, a device for welding workpieces is also suggested, particularly for the implementation of the method according to one of claims 1 to 11, which has the characteristics of claim 12. It comprises at least one contact pressure element which can be displaced in an oscillating manner and interacts with at least one of the workpieces to be welded together, for generating a zero gap between the workpieces, and is characterized by a control unit for the force-controlled and/or path-controlled adjusting of the oscillation movement of the contact pressure element during the welding process.

The force by which the contact pressure element is pressed against the workpiece and the path by which the contact pressure element is withdrawn at least when generating the outgassing gap are detected either by means of one and the same sensor or by means of one sensor respectively and transmitted to the control unit.

Additional advantageous embodiments of the invention are obtained from combinations of the characteristics indicated in the subclaims.

In the following, the invention will be explained in detail by means of the drawing.

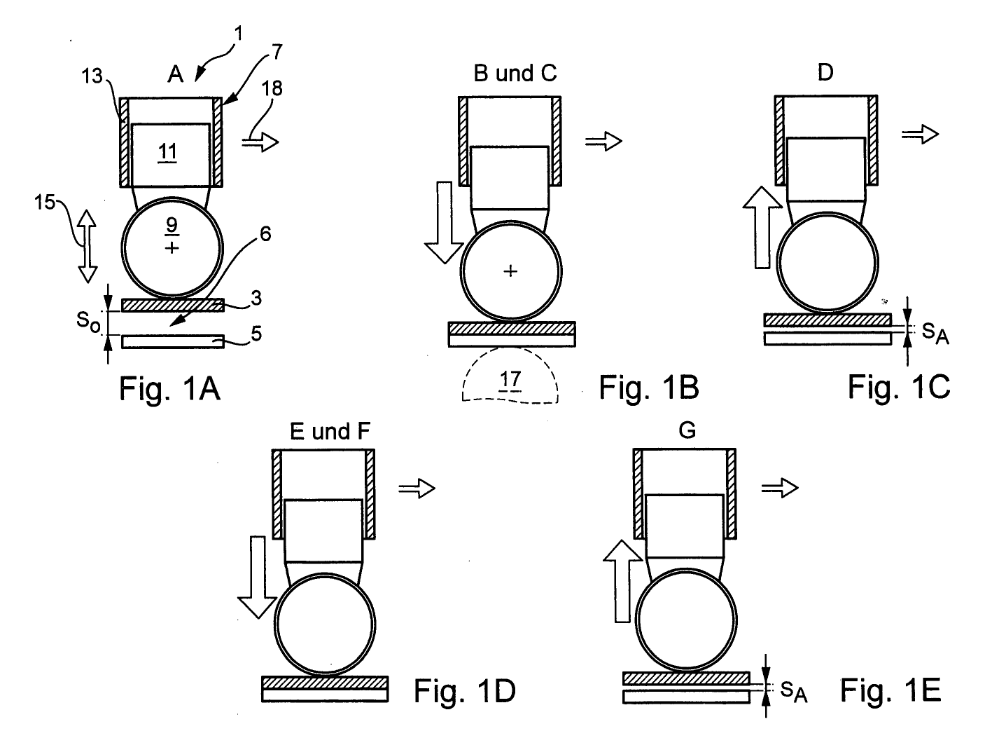

FIGS. 1A to 1E each are views of a cutout of an embodiment of the device according to the invention for welding workpieces, specifically a contact pressure element in different positions;

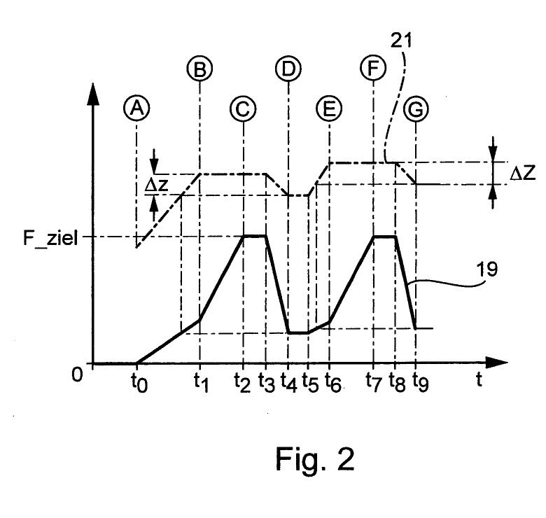

FIG. 2 is a diagram in which the contact pressure force of the contact pressure element illustrated in FIG. 1 and its path covered during the welding process is entered over the time; and

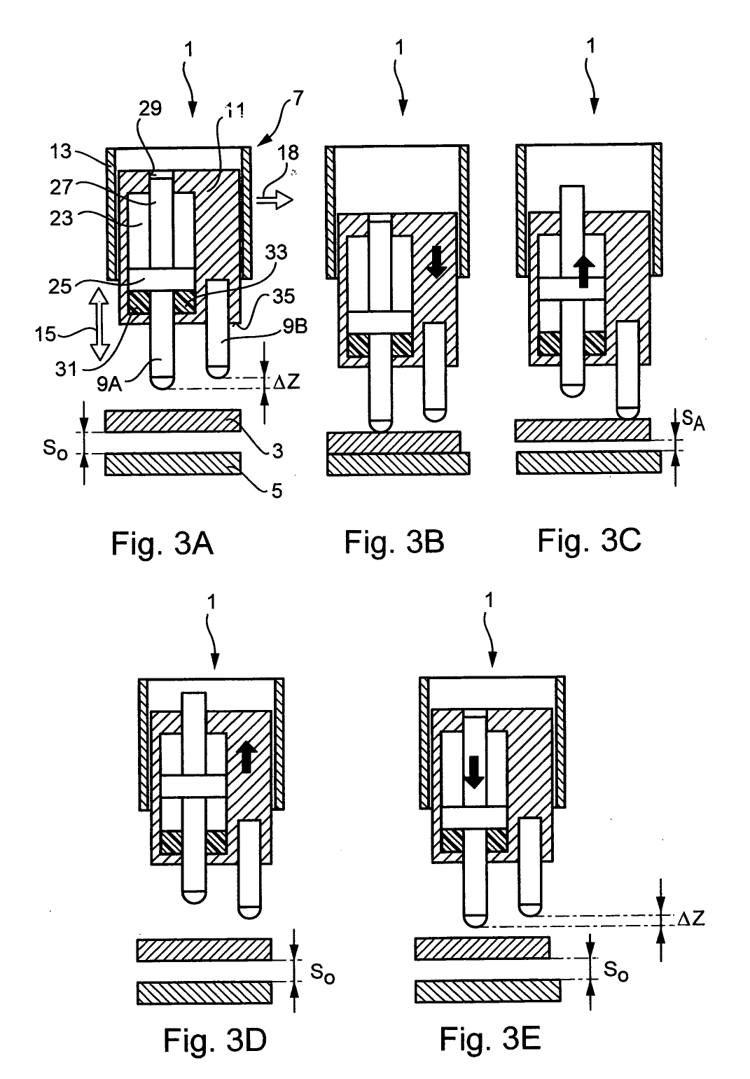

FIGS. 3A to 3E each are a cutout of a second embodiment of the device according to the invention for welding workpieces.

FIGS. 1A to 1E each illustrate a cutout of an embodiment of a device 1 for welding workpieces 3 and 5, which here are formed by vehicle body sheet metal parts, of which at least one is coated, for example, by means of zinc. The workpieces 3 and 5, which overlap one another in the area of the welding point 6, are aligned here parallel to an imagined horizontal line.

The device 2 comprises a beaming device, which is not shown, such as a laser beam device or an electron beam device, by which high-energy irradiation can be directed onto the welding point 6; and a contact pressure device 7, which can be moved by means of suitable devices, which are not shown, and in this manner can be positioned precisely opposite the welding point 6. By means of the device 1, a technical zero gap and an outgassing gap of a defined height can be alternately constructed during the welding operation between the workpieces, which will be explained in detail in the following. The construction and the function of the device 1 are generally known, so that in the following only individual components and their function will be described in detail.

It should be pointed out that, in the case of the embodiment described in FIGS. 1A to 1E, the high-energy irradiation is applied from the direction of a flat side of the workpieces to the welding point; that is, the irradiation penetrates at least one of the workpieces completely and in the process heats the other workpiece situated underneath or above.

The device 1 can be used for a spot welding of the workpieces 3, 5 as well as for producing a weld seam. For this purpose, by means of suitable conveying and positioning devices, either the device 1 is guided along or over the workpieces 3, 5 and/or the workpieces 3, 5 are moved past the device 1. In this case, high-energy irradiation, for example, a laser beam, can be stationarily arranged relative to the device 1 or can be moved along by means of an additional device not illustrated. In the case of the method described in the following, it is assumed that a weld seam is produced by means of the device 1, which means that, for this purpose, the device 1 is moved along the weld seam by means of the conveying and positioning devices, which are not shown.

In the embodiment illustrated in FIGS. 1A to 1E, the contact pressure device 7 has a contact pressure element 9 interacting with the upper workpiece 3, which contact pressure element 9 is formed here by a contact pressure roller. This contact pressure element 9 is coupled with a guiding part 11 which is displaceably disposed in a receiving part 13. The contact pressure element 9 is therefore linearly displaceable with respect to the receiving part 13 in the direction of the workpiece 3 and in the opposite direction, as indicated in FIG. 1A by a double arrow 15. Here, the displacing direction 15 of the contact pressure element 9 extends perpendicular to the exterior side of the workpiece 3.

The contact pressure device 7 also comprises a counterelement which is only outlined in FIG. 1B by means of a broken line and which is arranged opposite and at a distance from the contact pressure element 9. The counterelement 17, which interacts with the lower workpiece 5 during the welding operation, can be stationarily fixed with respect to the receiving part 13 and, during the contact pressing of the upper workpiece 3 onto the lower workpiece 5, has the purpose of preventing a yielding or deforming of the latter in the area of the welding point. The receiving part 13 and the counterelement 17 may, for example, be rigidly coupled with one another and have a uniform mutual spacing. If the lower workpiece 5 has a sufficiently stiff construction, the counterelement 17 can possibly be eliminated.

For producing the weld seam during the welding operation, the receiving part 13, together with the contact pressure element 9 arranged on it, are moved jointly with the counterelement 17 along the weld seam, as indicated by an arrow 18 in FIGS. 1A to 1E. In this case, the contact pressure element 9 is displaced by means of the guiding part 11 relative to the counterelement 17, which will be discussed in detail in the following.

The device 1 finally also has a control unit, which is not shown, for the force-controlled and/or path-controlled adjustment of the oscillation movement of the contact pressure element 9 during the welding process.

In the following, the method according to the invention will be described in detail by means of a welding operation, illustrated in FIGS. 1A to 1E, during which the oscillation movement of the contact pressure element 9 is alternately force-controlled and path-controlled. In FIG. 2, the temporal course of the force, which is applied by means of the contact pressure element 9 to the upper workpiece 3, is indicated by means of a line 19, and the temporal course of the path which the contact pressure element 9 covers relative to the receiving part 13, is indicated by means of a line 21. During the welding operation, the welding point will be acted upon by pulsed irradiation or preferably by continuous irradiation, whereby the workpieces 3, 5 are caused to melt in the area of the welding point.

FIG. 1A shows a starting position A, in which the workpieces 3, 5 are arranged in the clearance between the contact pressure element 9 and the counterelement 17. The lower workpiece 5 rests against the counterelement 17 and is supported by the latter. The upper workpiece 3 is deposited on the lower workpiece in a force-free manner; that is, it is not pressed onto it, so that only its own weight acts upon the lower workpiece 5. Because of the thickness of the workpieces 3, 5, which is only very small at least in the area of the welding point and, in the case of vehicle body metal sheets, is normally in the range of between 0.70 mm and 1.50 mm, when the metal sheets are placed upon one another, a gap So, whose height may amount to several 1/10ths of a millimeter, is formed as a result of material-caused or manufacturing-caused inaccuracies. In FIG. 2, the starting position illustrated in FIG. 1A is marked “A”. It is clearly visible that, although the contact pressure element 9 is already in contact with the upper workpiece 3, it does not act upon it by a force.

The welding process is started from the starting position A (FIG. 1A) at the time to. First a technical zero gap is generated between the workpieces 3, 5 in that the contact pressure element 9 is displaced downward in the vertical direction until there is no longer a gap between the workpieces 3, 5 and workpiece 3 in the area of the welding point rests flatly against the workpiece 5 supported by the counterelement 17, as illustrated in FIG. 1B. Even now the welding point can be acted upon by the high-energy irradiation. In this phase of the welding operation, the displacement of the contact pressure element 9 is exclusively force-controlled; that is, the contact pressure force exercised by the contact pressure element 9 upon the upper workpiece 3 is increased until it is so large at the time ti that the workpieces rest flatly against one another in the area of the welding point and the displacement movement of the contact pressure element 9 is therefore almost concluded. This point is marked “B” in FIG. 2.

In the next step, the contact pressure force is now increased further until it reaches a defined value F_target, which takes place at the time t₂. This point of the force control is marked “C” in FIG. 2.

The contact pressure force F_target will then be maintained for an adjustable period of time (t₃-t₂) to the point in time t₃. During this time, the workpieces 3, 5 are heated to such an extent that their coatings start to evaporate. As a result of the fact that no gap, thus a zero gap, exists between the workpieces 5,3, the forming vapors cannot escape and the pressure begins to rise. The time duration in which a zero gap exists between the workpieces is adjusted such that the vapor pressure is not high enough for a melt ejection to take place.

In the next step, by means of path control, a defined outgassing gap S_{A} is now generated between the workpieces 3, 5, so that the gases and vapors occurring during the welding operation can escape. This takes place by the path control of the contact pressure element 9 which is withdrawn by a defined path Δz; that is, its distance from the counterelement 17 is enlarged by the path Δz. The withdrawal takes place by a displacement of the contact pressure element 9 in the vertical direction upward into the position illustrated in FIG. 1C. During the withdrawal of the contact pressure element 9, the outgassing gap S_{A} is formed in that the upper workpiece 3 elastically deformed when pressed against the lower workpiece 5 is now deformed back as a result of its spring-elastic characteristics, in which case it continues to rest against the contact pressure element 9, as illustrated in FIG. 1C. At the point in time t₄, the outgassing gap S_{A} is produced whose height is as large as the path Δz by which the contact pressure element 9 was withdrawn. This point is marked “D” in FIG. 2. FIG. 2 shows clearly that, as a result of the withdrawal of the contact pressure element 9, also the force exercised on the upper workpiece 2 is reduced to a correspondingly lower value which in a preferred embodiment is greater than zero. This means that the contact pressure element 9 is not lifted off the upper workpiece 3, whereby an outgassing gap would form which has an undefined height. Thus, the upper workpiece 3 continues to be acted upon by a force which is clearly lower than the target force F_target when the outgassing gap S_{A} has been generated.

After the outgassing gap S_{A} has been maintained for an adjustable time duration (t₅-t₄) to the point in time t₅, a zero gap is generated again. For this purpose, the displacement of the contact pressure element 9 is again force-controlled. The contact pressure element 9 is vertically displaced downward so far that the upper workpiece 3 is pressed flatly against the lower workpiece 5, which takes place at the point in time t₆, which is marked “E” in FIG. 2 (FIG. 1D). Then the contact pressure force is increased further until it reaches the defined target value F_target at the point in time t₇. This operating point is marked “F” in FIG. 2. The contact pressure force F_target is maintained to the point in time t₈. Then, for the repeated generating of the outgassing gap S_{A}, the contact pressure element 9 is withdrawn/displaced by the path Δz into the position illustrated in FIG. 1E while forming the outgassing gap S_{A}. The outgassing gap S_{A} has been generated at the point in time t₉.

It can be defined how often during a welding process an outgassing gap S_{A} and a zero gap are produced. This can, for example, be a function of the type of coating, the thickness of the workpieces and the like.

As described above, the contact pressure device 7 (receiving part 13, contact pressure element 9, counterelement 17) is moved along the weld seam during the welding operation; that is, the oscillation movement of the contact pressure element 9 is superimposed on the translatory movement of the contact pressure device 7.

The method described by means of FIGS. 1A to 2 has the special advantage that an outgassing gap S_{A} can be generated which has a defined reproducible height. In this context, it should be pointed out that the displacement of the contact pressure element 9 is path-controlled for generating the outgassing gap S_{A} and is force-controlled for generating the zero gap.

The above-described mode of controlling the oscillation movement of the contact pressure element 9 has the advantage that, also in the case of an unintended position change of the second workpiece 5 or of the counterelement 17 and/or of the receiving part 13 holding the contact pressure element 9 during the welding process, which may occur, for example, as a result of an undesired movement of a robot holding the receiving part 13 or the counterelement 17, an outgassing gap S_{A} with the desired height can nevertheless again be generated after the zero gap was produced beforehand. In this regard, reference is made to FIG. 2 which shows that, after the outgassing gap S_{A} was generated the first time, for generating the zero gap at the point in time t₆, the contact pressure element 9 was displaced by a distance which is greater than the path Δz by which the contact pressure element 9 had previously been withdrawn in order to generate the defined outgassing gap S_{A} for the first time.

It should be pointed out that, after the zero gap has been established for the first time (point in time t₁), the upper workpiece 3 is acted upon by force by means of the contact pressure element 9 during the entire further welding operation. In other words, the oscillation movement of the contact pressure element 9 with a low amplitude is superimposed on the contact pressure force such that the contact pressure force cannot fall to zero.

The method according to the invention can, for example, also be used for welding high-strength and super-high-strength materials. Because of the high quality of the produced weld seams, the dimensional accuracy of the component formed of the welded-together workpieces and thus its quality can be improved. The method can be used particularly advantageously in the vehicle body shell construction for welding together coated steel or aluminum parts.

If the workpiece 5 illustrated in FIGS. 1A to 1E has sufficient stiffness, the counterelement 17 can be eliminated. It is important that, during the contact pressing of the upper workpiece 3 by means of the contact pressure element 9, the lower workpiece 5 does not yield or is not deflected at all or only to a harmless extent. Should the workpiece 5 move during the welding operation, when generating the zero gap, the contact pressure element is simply, by means of the force control, guided correspondingly far or, when the distance is reduced, is displaced less far until the contact pressure force has reached its value F_target.

If the counterelement 17 can be eliminated during the welding, only a one-sided accessibility of the welding point is required, specifically from the side of the contact pressure element 9. This results in more freedoms for the component design. In addition, the construction of the device 1 can be simplified and thus its cost can possibly be reduced.

In a preferred embodiment of the device 1, it is provided that the high-energy radiation is applied to the welding point from the side on which the contact pressure element 9 is also situated.

FIGS. 3A to 3E show another embodiment of the device 1 in different operating positions. Identical parts are provided with the same reference numbers, so that, in this regard, reference is made to the description of the preceding figures. The contact pressure device 7 has a first contact pressure element 9A and a second contact pressure element 9B which both interact successively with the upper workpiece 3. The contact pressure elements 9A, 9B, each constructed here as a contact pressure pin, are arranged on a common guiding part 11 which is displaceably disposed in a receiving part 13. The contact pressure element 9A is movably arranged on the guiding part 11, while the second contact pressure element 9B is rigidly, thus in an immobile manner, mounted on the guiding part 11. The first contact pressure element 9A is connected with a piston 25 which is guided in a recess 23 and has a piston rod 27 on its side facing away from the contact pressure element 9A, which piston rod 27, in turn, is guided in a passage opening 29 in the guiding part 11.

In FIG. 3A, the piston 25 has moved into a lower end/stop position, in which it rests on a stop element 33 arranged at the bottom 31 of the recess 23. In this position—viewed in the direction of the contact pressure force which will act upon the workpieces at a later point in time—the first contact pressure element 9A is arranged by the measurement Δz in front of the second contact pressure element 9B. As illustrated in FIG. 3A, the contact pressure element 9A projects precisely by the extent Δz farther beyond the face of the guiding part 11 facing the workpieces 3, 5 than the contact pressure element 9B.

By means of the device 1 illustrated in FIGS. 3A to 3E, the relative movement between the workpieces 3, 5 can be force-controlled during the welding operation, which will be explained in detail in the following.

FIG. 3A shows a starting position in which the workpieces 3, 5 are placed on one another in a force-free manner. As a result, as described above, an undefined gap S₀ of a height of up to several 1/10ths of a millimeter is formed between the workpieces 3, 5. The receiving part 13 is situated opposite the first workpiece 3. The first contact pressure element 9A is displaced into its end position in which—viewed in the direction of the workpieces 3, 5—it projects by the extent Δz beyond the second contact pressure element 9B. In the case of the fixed receiving part 13, for generating the technical zero gap, the guiding part 11 is moved out of the receiving part 13 until the first contact pressure element 9A abuts the upper workpiece 3 and presses the latter with a defined force onto the lower workpiece (FIG. 3b). The guiding part 11 is now held in this position, while the first contact pressure element 9A, as a result of a displacement of the piston 25, is moved in the vertical direction upward away from the workpiece 3. Because of its spring-elastic restoring forces, the workpiece 3 places itself on the second contact pressure element 9B, whereby the outgassing gap S_{A} is formed (FIG. 3C). The height of the outgassing gap S_{A} is exactly equally large as the distance Δz which the contact pressure elements 9A, 9B have from one another when the contact pressure element 9A is displaced in the end position (FIG. 3A).

Before now a technical zero gap is again generated between the workpieces 3, 5, first the second contact pressure element 9B is lifted off the workpiece 3, which takes place by a displacement of the guiding part 11 (FIG. 3D). In this case, an undefined gap S₀ forms again between the workpieces 3, 5, which is larger than the outgassing gap S_{A}. Finally, as illustrated in FIG. 3E, the first contact pressure element 9A is again moved in front of the second contact pressure element 9B in that the piston 25 is moved against the stop element 33. Now the steps describes by means of FIGS. 3A to 3D are carried out again. How often a defined outgassing gap S_{A} is produced during the welding operation can be defined and is selected, for example, as a function of the workpiece thicknesses, of the material and the like.

It should be pointed out that, because of the mechanical coupling of the two contact pressure elements 9A, 9B, a force control of the oscillation movement is sufficient for establishing a desired outgassing gap S_{A}, in which case the force control is also only used for generating the technical zero gap, while the subsequent forming of the outgassing gap S_{A} is implemented exclusively by the mechanical coupling of the two contact pressure elements 9A, 9B.

The embodiments of the device 1 described by means of the figures have in common that, during the welding operation, an outgassing gap S_{A} with an adjustable gap height and high precision can be reproducibly adjusted without the requirement that, for this purpose, one of the workpieces has to be provided with molding characteristics serving as spacers.

1. Method of welding workpieces (3, 5), particularly coated workpieces, by which, by means of a device (1), at least at the welding point, alternately a zero gap and an outgassing gap (S_{A}) adjustable in its height for the escape of the gases and vapors occurring during the welding operation are generated, for this purpose at least a first workpiece (3) being moved relative to a second workpiece (5), characterized in that the relative movement between the workpieces (3, 5) is force-controlled and/or path-controlled.

2. Method according to claim 1,
characterized in that, for generating an outgassing gap (S_{A}) between the workpieces (3, 5) to be welded, of which preferably at least one is a sheet metal part, the workpieces (3, 5) are placed upon one another at the welding point in a force-free manner, the height of the gap (S₀) being—preferably exclusively—determined by material-caused and/or manufacturing-caused inaccuracies of the workpieces (3, 5).

3. Method according to claim 1 or 2,
characterized in that the outgassing gap (S_{A}) has a height which is in the range of from 0.1 mm to 1 mm and preferably amounts to approximately 0.1 mm to 0.3 mm.

4. Method according to one of claims 1 to 3,
characterized in that, for generating the technical zero gap between the workpieces (3, 5) at the welding point at least one of the workpieces (3) is pressed by means of at least a first contact pressure element (9; 9A) with a defined adjustable contact pressure force (F_target) against the other workpiece (5).

5. Method according to claim 4,
characterized in that the first contact pressure element (9) is displaced back by a defined adjustable path (path Δz) after the technical zero gap was generated between the workpieces (3, 5) and maintained for a definable time period, and in that, in the process,the outgassing gap (S_{A}) between the workpieces (3, 5) is generated—preferably exclusively on the basis of the material-caused restoring forces of the at least one workpiece (3) interacting with the contact pressure element (9).

6. Method according to claim 4,
characterized in that, after the technical zero gap has been generated between the workpieces (3, 5) and was maintained for a definable time period, the contact pressure force (F_target) is reduced to a definable value, so that the outgassing gap (S_{A}) is generated between the workpieces (3, 5)—preferably exclusively on the basis of the material-caused restoring forces of the at least one workpiece (3) interacting with the contact pressure element (9).

7. Method according to claim 5 or 6,
characterized in that, after a definable time period, a technical zero gap is formed again between the workpieces (3, 5) in that the first contact pressure element (9; 9A) presses the one workpiece (3) with a defined adjustable contact pressure force (F_target) against the other workpiece (5).

8. Method according to one of claims 1 to 4,
characterized in that, after the technical zero gap was generated between the workpieces (3, 5) and was maintained for a definable time period, the first contact pressure element (9A) is displaced back so far that a second contact pressure element (9B)—viewed in the direction of the contact pressure force (F_target)—is arranged in front of the first contact pressure element (9A) and at a definable distance with respect to the zero gap, onto which the workpiece (3) places itself or is placed which previously was interacting with the first contact pressure element (9a), while forming the outgassing gap (S_{A}).

9. Method according to claim 8,
characterized in that after a definable time period, a technical zero gap is formed again between the workpieces (3, 5) in that the first contact pressure element (9A)—viewed in the direction of the contact pressure force (F_target)—is moved by a distance (Δz) corresponding to the height of the desired outgassing gap (S_{A}) in front of the second contact pressure element (9B), and then both contact pressure elements (9A, 9B), while maintaining their distance (Δz) from one another, are moved so far in the direction of the workpieces (3, 5) that the first contact pressure element (9A) presses the one workpiece (3) with a defined adjustable contact pressure force (F target) against the other workpiece (5).

10. Method according to one of claims 1 to 9,
characterized in that a zero gap and an outgassing gap (S_{A}) between the workpieces (3, 5) are formed at least once during the welding process.

11. Method according to one of claims 1 to 10,
characterized in that the workpieces (3, 5) to be welded are welded to one another by means of a high-energy, preferably continuous irradiation.

12. Device for implementing the method according to one of claims 1 to 11, having at least one oscillatingly displaceable contact pressure element (9; 9A, 9b) interacting with at least one of the workpieces (3, 5) to be welded together, for generating a zero gap between the workpieces (3, 5),
characterized by a control unit for the force-controlled and/or path-controlled adjustment of the oscillation movement of the contact pressure element (9; 9A, 9B) during the welding process.

13. Device according to claim 12,
characterized in that the control unit has at least one sensor for determining the contact pressure force of the contract pressure element (9) onto the workpiece (3) and/or the displacement path of the contact pressure element (9).

14. Device according to claim 12 or 13,
characterized by at least two mechanically mutually coupled contact pressure elements (9A, 9B).

15. Device according to one of claims 12 to 14,
characterized in that the contact pressure element (9; 9A, 9B) can be force-lockingly or form-lockingly coupled with at least one of the workpieces.
